(19) United States
(12) Patent Application Publication
(10) Pub. No.: US 2005/0109190 A1
(43) Pub. Date: May 26, 2005

(54) Dampening material for a drum

(75) Inventors: Lane Smith, Fort Worth, TX (US); Jeff Busby, Fort Worth, TX (US)

Correspondence Address: Daniel D. Chapman, Esq.;JACKSON WALKER L.L.P., 112 E. Pecan Street, Suite 2100, San Antonio, TX, 78205, US

(73) Assignee: Aviation Devices & Electronic Components, Inc.

(21) Appl. No.: 10/722,898

(22) Filed: Nov. 26, 2003

(51) Int. Cl. G10D 13/02

(52) U.S. Cl. 84/414

(57) ABSTRACT

A device for dampening a vibratable surface, such as a drumhead. By dampening the vibrations of a vibratable surface, such as a drumhead, the tone may be altered, as by removing some of the higher pitched overtones of the vibratable surface. The patch comprises a resilient, pliable adhesive body that has an intrical, flexible. And a preferred embodiment, the body is substantially oil free polyurethane mix and the flexible base is foam. A method of manufacturing the patch is provided. The method includes a step of combining, on a flat top surface such as a table, a curable liquid mix and an open cell foam, and allowing the mix to cure.

### FIELD OF THE INVENTION

Dampening devices for vibrating drumheads and percussion instruments, more specifically a dampening device comprising an elastomeric body which incorporates a base substrate.

### BACKGROUND OF THE INVENTION

Vibrating surfaces are used to generate, at least when struck by a skilled musician, pleasing musical tones. Percussion instruments, including drums, vibrate at fundamental wavelengths defined in part by the diameter of the instrument. Drums and percussion instruments can also vibrate in such a way as to produce unwanted and undesirable overtones, sometimes referred to as ring or over-ring. There have been a number of devices in the prior art that have been designed to dampen the vibration of a percussion instrument, for example a drumhead, to help eliminate unwanted, overtones and over-ring.

Most of the prior art devices feature contacting the drumhead with substance, the substance capable of absorbing some of the higher overtones. For example, U.S. Pat. No. 5,637,819 discloses a gel patch wherein the gel is two-phase colloidal system consisting of a solid and liquid phase, containing in an exemplary embodiment, 3% soybean oil.

U.S. Pat. No. 4,154,137 discloses a mute element that includes a support arm structure for supporting the mute element from the sidewall of the drum, against the drumhead.

The gel patch and the base supported dampener achieve similar results, albeit the gel patch does not require the external support arm.

Prior art “patch type” dampening materials, when applied to the vibrating dome head, have had some shortcomings. Among these shortcomings are the seepage of oil, sometimes with an unsightly stain, onto the surface of the drumhead by the material comprised in the gel patch. Another shortcoming includes the inability to effectively “stick” to the drumhead. Yet another shortcoming disclosed in some of the prior art patch dampening devices is their relative ineffectiveness at dampening certain overtones. Last, some patch materials may ‘dry out’ over a period of time, thus lessening their dampening ability.

With a view towards minimizing or eliminating some of these shortcomings, applicant provides a drum, drumhead, and percussion instrument dampening material that comprises a patch including an elastomeric body, typically silicon free polyurethane, and a flexible substrate or base, typically open cell foam. The resulting patch has been found to effectively adhere to a vibrating drumhead surface without leaving unsightly stains and to provide a long life with effective dampening of drum overtones. Furthermore, applicants dampening material has been shown to adhere to both top (batter) and bottom (resonant) drumheads with equal effectiveness. Applicants material may also be moved or relocated on the surface of drumheads and other percussion instruments numerous times without leaving any residues behind.

Applicants herein also provide for a novel method of making a novel patch, wherein a two part mix is combined, typically at a one-to-one ratio, as liquid, while it is being applied to a flat surface. The liquid may be self leveling and upon leveling the substrate or base is applied to the mix, typically so the mix saturates the substrate and then the mix is allowed to cure.

### BRIEF DESCRIPTION OF THE PREFERRED EMBODIMENT

FIG. 1 is a top elevational view of a base or substrate for use with applicants novel dampening material.

FIG. 2 is a side elevational view, cutaway in cross section, illustrating a “sandwich” variety of applicants novel dampening material.

FIG. 3 illustrates an embodiment of applicants novel dampening material, in side elevational view, showing that the embodiment may include a tabular substrate, at least partially saturated with a curable liquid polyurethane mix, which may extend substantially beyond one surface of the substrate and, on an opposite surface either does not extend at all beyond the substrate or extends only in a thin layer beyond the substrate.

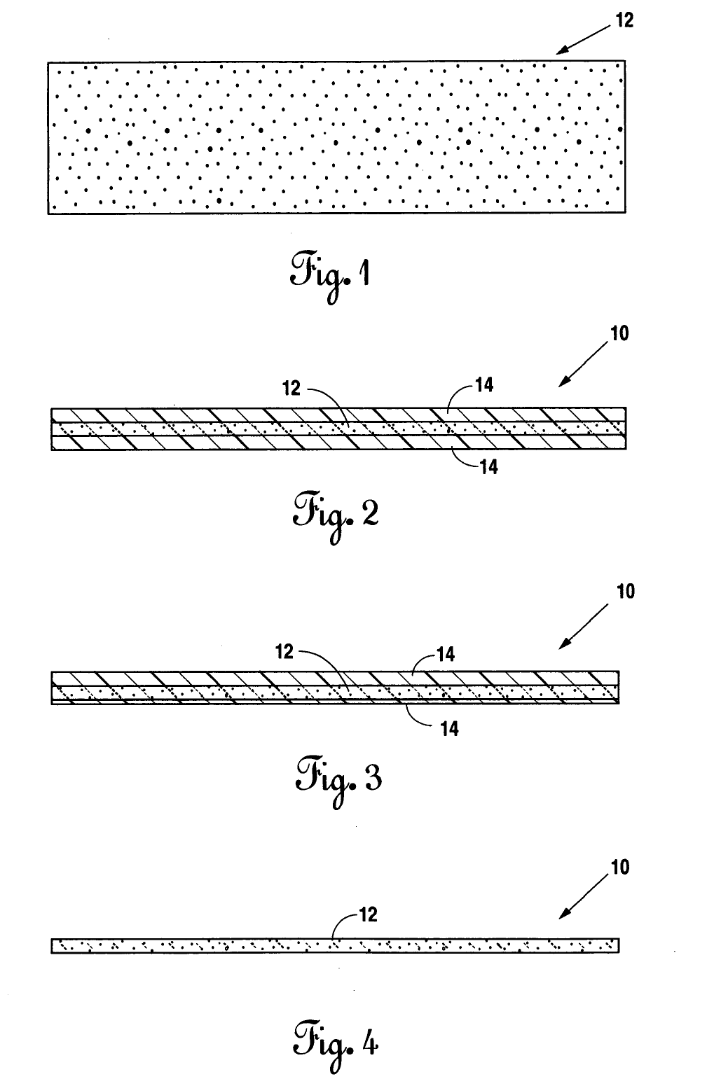

FIG. 4 illustrates yet another embodiment of applicants novel invention including a substrate, for example open cell foam, that is at least partially saturated with a curable liquid polyurethane mix and in which there is little or no extension of the polyurethane mix beyond the borders of the at least partially saturated foam substrate.

FIG. 5 illustrates a side elevational view of applicants novel dampening material supplied as an elongated tape, from which sections may be cut, to be applied to a vibrating surface.

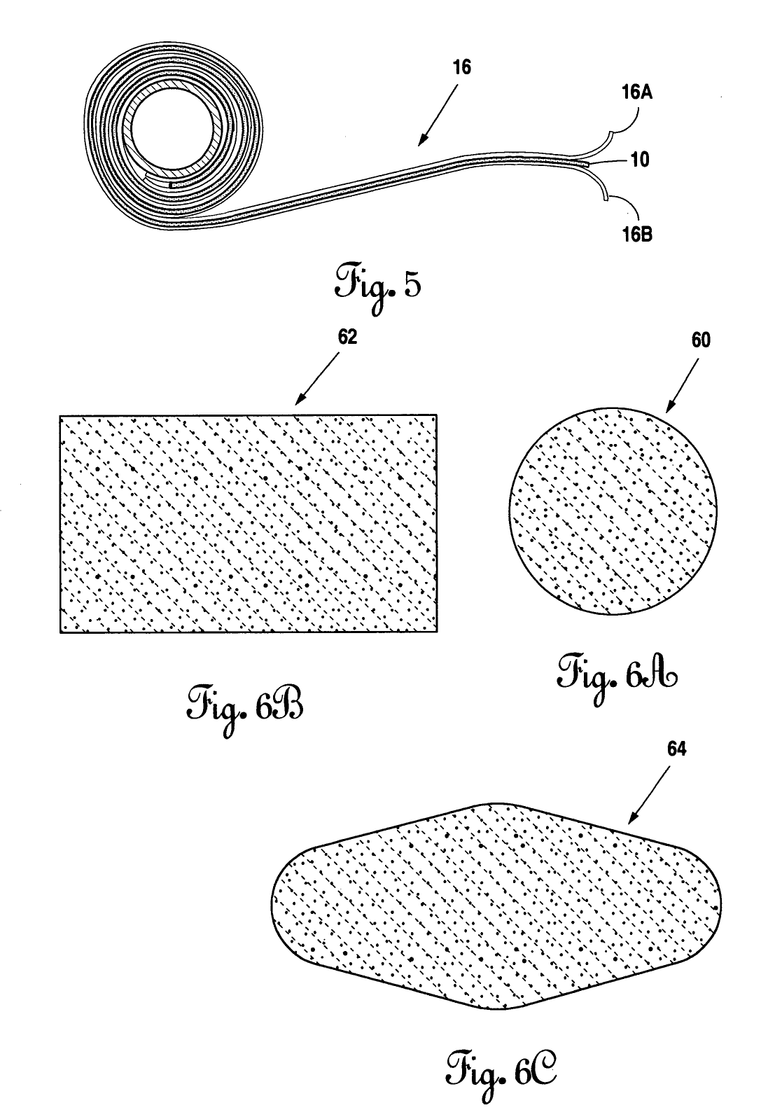

FIGS. 6A, 6B and 6C illustrate in top elevational views, just three of the forms in which applicants novel dampening device may be provided, for attachment to a vibrating surface.

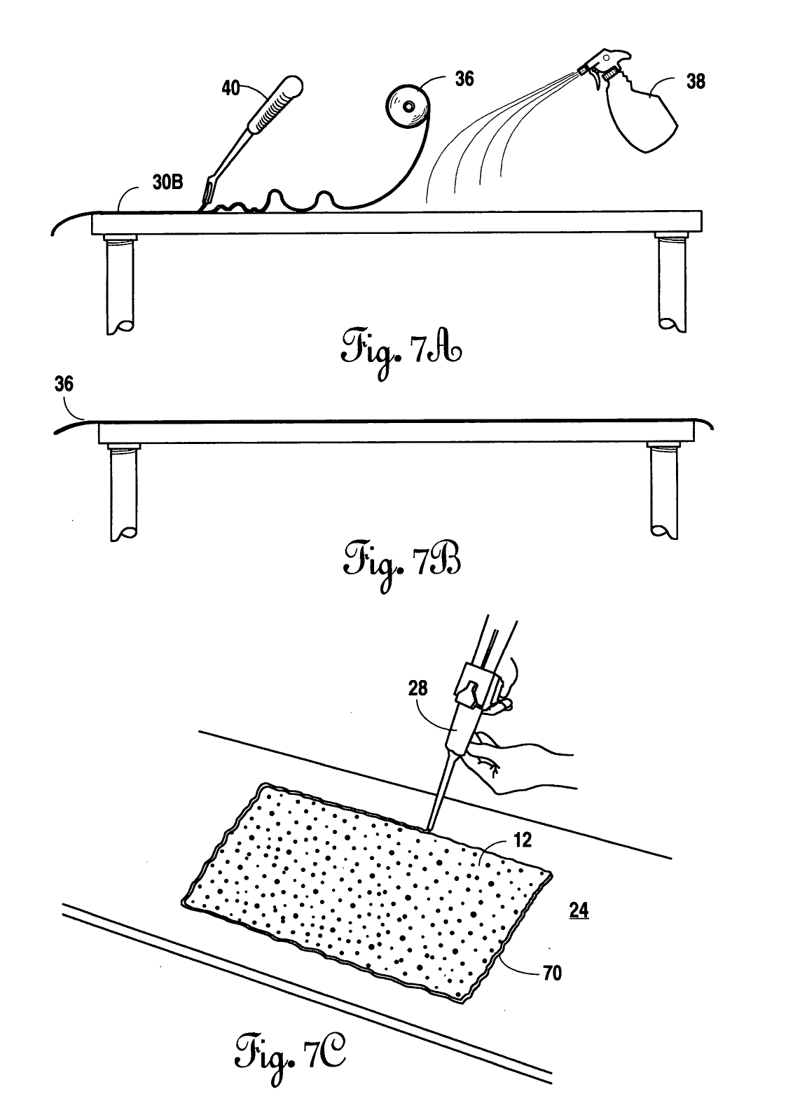

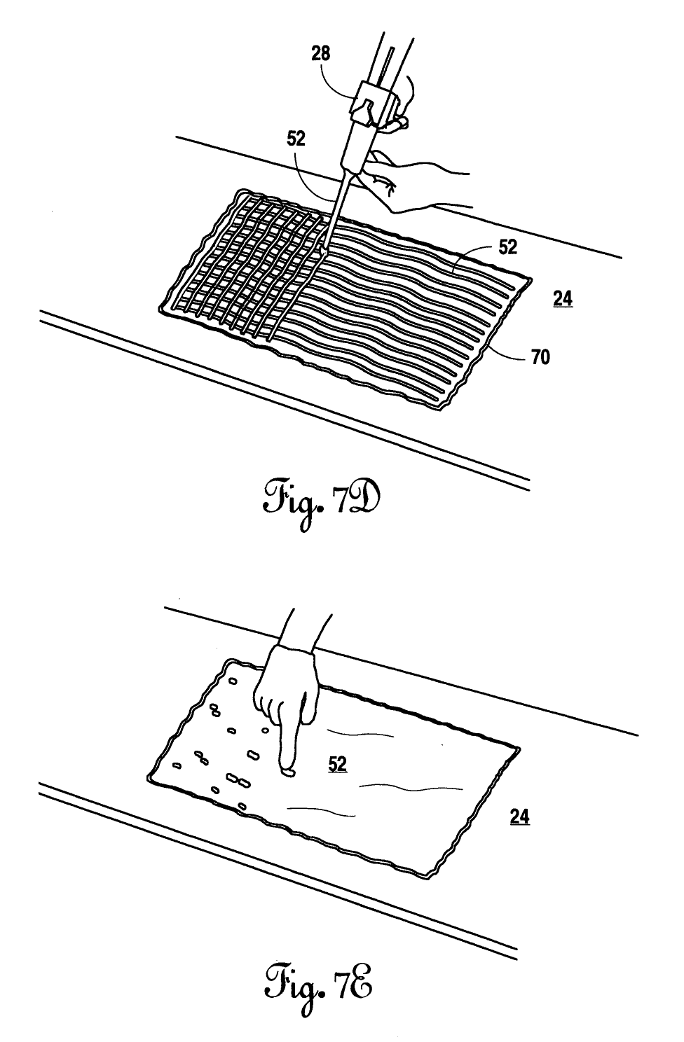

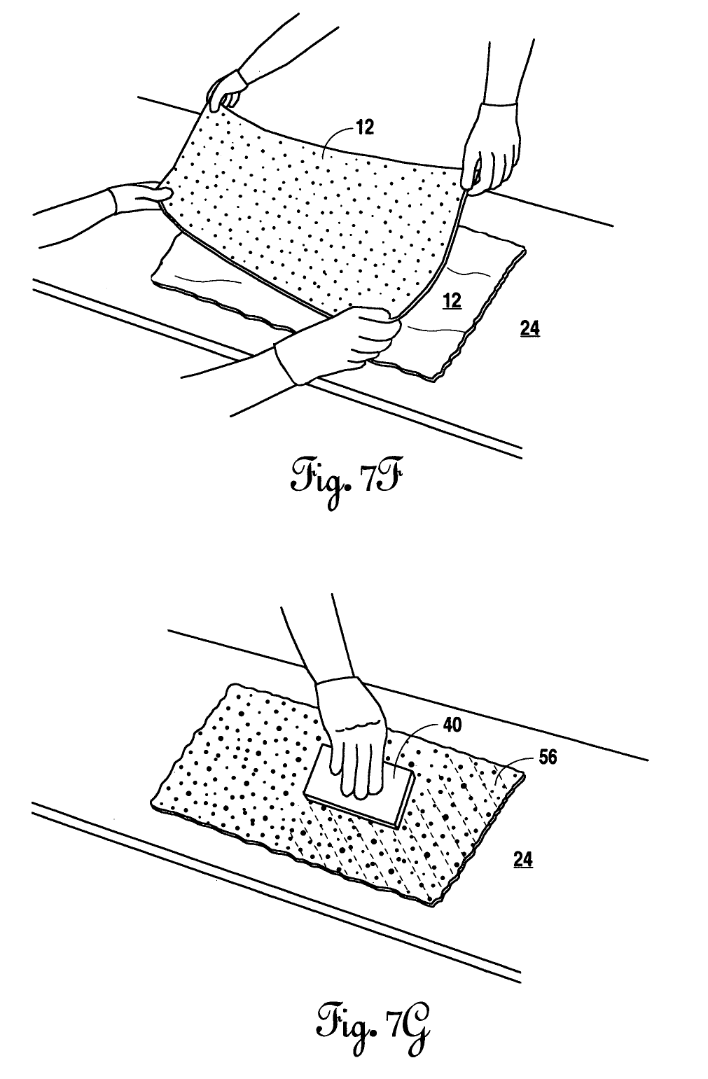

FIGS. 7A-7H provide illustrations for a process for manufacturing applicants novel dampening material.

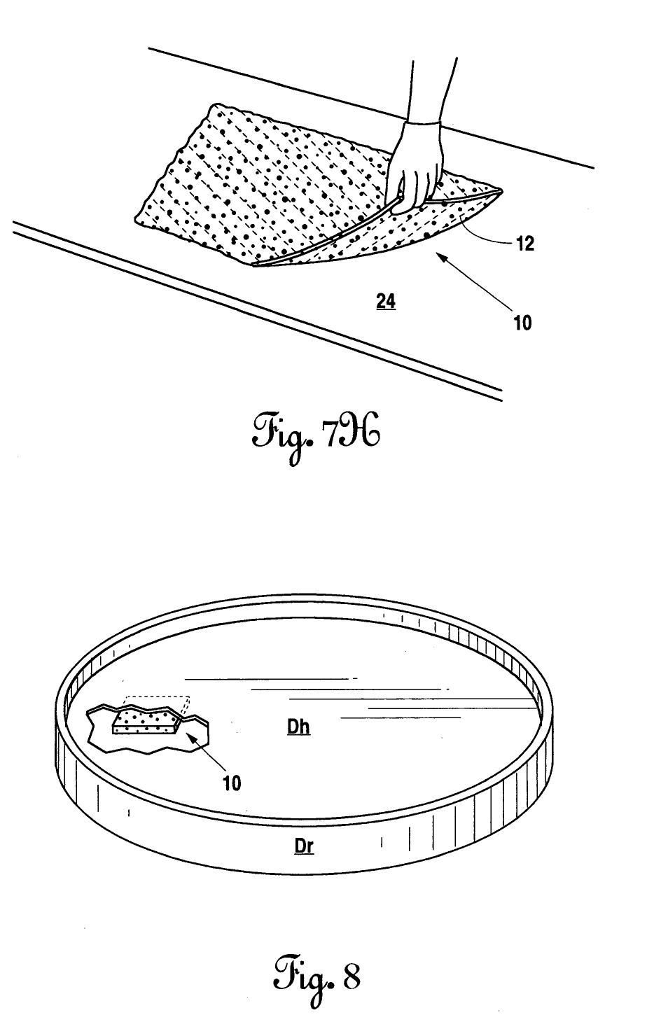

FIG. 8 is a perspective view illustrating the application of applicants novel dampening material to a drumhead for effectively dampening the same.

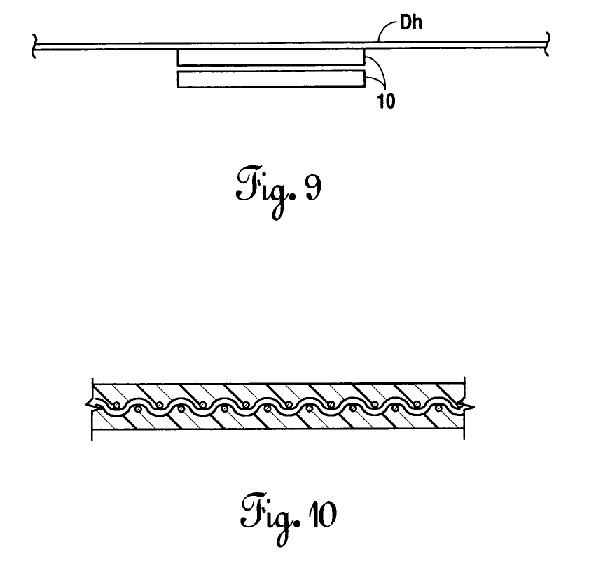

FIG. 9 illustrates, in side elevational view, a manner of “stacking” two of applicants novel patches to perform effective dampening for a vibrating drumhead.

FIG. 10 is a side elevational view, cutaway of an alternate embodiment showing the use of a woven base as a substrate for applicants novel dampening material.

### DETAILED DESCRIPTION OF THE PREFERRED EMBODIMENT

FIG. 1 illustrates a base or substrate 12, for example, a dry open cell foam substrate before applicants mix is added.

FIGS. 2, 3 and 4 are side views cutaway of applicants novel dampening material (10). In FIG. 2 it is seen that one embodiment includes a dampening material 10 with a cured polyurethane mix (14) forming a bottom surface and top surface to at least partially polyurethane mix saturated foam substrate or core (12). In this embodiment of a dampening material it is seen that core (12) is approximately centrally located between top and bottom surface portions comprising a cured polyurethane mix.

Turning now to FIG. 3 it is seen that the at least partially saturated foam core has a thin or no layer on one side and a thicker layer of cured polyurethane mix extending beyond the other side of the at least partially saturated foam core or substrate (12).

FIG. 4 illustrates a third embodiment of applicants novel dampening material (10) which includes an at least partially saturated core (12) with little or no additional cured mix extending beyond the saturated core.

Thus it is seen that applicants novel dampening material (10) may come in different forms. First, it may include an at least partially saturated core which may stand alone or which may have, on one side or the other (or both sides) a layer of cured polyurethane mix which is typically integral with the foam of the foam core. However, the substrate or foam core may be closer to the top or the bottom of the patch of dampening material and the core need not be centered as illustrated in FIG. 2. Applicants have found that when the core is closer to one side of the dampening material then the other (for example FIG. 3) there is a tackiness differential between the two surfaces, with a more tacky surface on one side, which side would face the vibrating drumhead, for adhering the patch or dampening material to the drumhead.

FIG. 5 illustrates a roll of tape (16) which includes releasable protective sheets 16A and 16B on the top and bottom surfaces of an elongated, rolled section of applicants novel dampening material (10), to protect the sticky surfaces. These are typically peeled off before use of the patch.

FIGS. 6A, 6B and 6C illustrate a circular (60), rectangular (62) and complex (64) shape in which applicants novel dampening material (10) may take. Typically a rectangular shape has proven effective but for some purposes different shapes or sizes may be used to effect different damping characteristics.

FIGS. 7A through 7H illustrate a preferred method of making applicants novel material (10). The steps illustrated may be broken down generally into three categories. First, preparing a table (24). Second, pouring or applying a polyurethane mix (52), typically in a one-to-one ratio and typically self leveling, onto the table. Third, combining the core substrate, typically foam and the mix. The mix is then allowed to cure and the dampening material (10) is removed from the table.

FIGS. 7A and 7B illustrate a method of preparing a flat top, typically glass table (24). A flat top table (24) is provided typically including a flat, transparent glass member. A release sheet (36), such as a sheet of FEP, is laid across the table after the table is sprayed with a cleaner (38) or water. Bubbles are usually squeegeed out from between the release sheet and the table using a squeegee (40). Applicants have found that, instead of a release sheet, a 1.5 mil polyurethane sheet may be provided. This will become a “skin” to the less sticky side of the patch. That is, where the method set forth, above and below discloses lift off of the patch from the release sheet, in a preferred embodiment a 1.5 mil sheet is laid on the table and the mix has some adherence and bonding to the sheet. When the process is completed, the cured mix is lifted off with the polyurethane sheet, which becomes a “skin” to one side of the patch (typically the non-sticky side). This allows easy handling by the musician drummer—one can handle the patch by the protected “skinned” side and keep their fingers off the sticky side.

FIG. 7C illustrates a sheet of dry, open cell foam substrate (12) laying on top of the table (24) and more specifically shows a step of applying a polyurethane border (70) around the sheet of the foam, but typically not touching the foam edges. This border is used to define the area in which the mix will be laid which is illustrated in 7D. Turning back to FIG. 7C, after the border is applied, the sheet of foam is removed and now the step of layering the mix to the table, as illustrated in FIG. 7D is commenced. In this step, a gun or applicator (28) is filled with mix (52). The mix is typically a liquid polyurethane that cures to form a resilient substantially oil free, elastomeric body. One such two part mix is available from KBS Chemical from Fort Worth, Tex. as part numbers P-1011 (polyol) and U-1010 (urethane).

Applicator (28) typically has a nozzle that will allow the polyol and urethane to combine into a one-to-one ratio and mix as its being applied. A crisscross action has been found to be an effective method of application of the mix on the table enclosed by the border (70). The mix is typically self leveling and the crisscross pattern will cause it to flow together, somewhat. However, manual application, such as illustrated in FIG. 7E may assist the mix (52) to level and to “debubble”. The worker may manipulate the mix into the dry areas as illustrated in FIG. 7E.

FIG. 7F illustrates the placement step wherein the foam substrate (54) is placed on the level mix (52). The mix is worked into the substrate. Alternatively, the substrate may be laid onto the table dry and mix applied to the substrate.

FIG. 7G illustrates a step of soaking wherein the dry, open cell foam substrate (54) becomes at least partially saturated, and typically saturated, with a polyurethane mix. Manual pressing on the surface of the foam as well as squeegeeing (illustrated) will assist in urging the polyurethane mix into the substrate (54) and will help work out bubbles in the mix and substrate. After the desired degree of saturation is reached, the polyurethane mix is allowed to cure. After curing, typically at room temperature for approximately two to four hours, the dampening material (10) is lifted from the table as illustrate in 7H.

If one desires that the at least partially saturated foam substrate core (56) should have a top and layer of polyurethane mix (52) as illustrated in FIG. 2 (“sandwich”), then a greater volume of polyurethane mix, above and below the core is required. One can control the existence of or thickness of a polyurethane mix layer outside the core by increasing the volume of polyurethane mix applied. If only a saturated core is desired with substantially more polyurethane mix extending beyond the boundaries of the core, then the core can be squeegeed clean of any excess mix before curing.

For example, the following procedure may be used for one desiring to make a saturated foam core with substantially little or no layer of cured polyurethane mix on either side. A 12 inch by 36 inch 0.070 inch thick foam sheet above is placed on the table. About 150 cc of polyurethane mix is placed in the applicator (28). The steps described above are undertaken and about 30 cc of uncured mix is squeegeed off the top of saturated foam core, with the edge of the squeegee resting gently up against the top surface of the saturated foam core when the squeegee is drawn across the face of the foam core. The estimate of 30 cc's may be made by simply eyeing the excess material or placing it on a piece of FEP film and weighing it.

For the preparation of a “one-sided” dampening patch, one would simply squeegee off less of the excess squeegeed off to make a substantially “borderless” foam core. For example, if about 20 cc's is removed from the original 150 cc's applied, this would result in about a 0.005 inch layer of cured mix beyond the substrate. The thickness may be estimated and a shinier finish results when a thin layer of mix is provided. Use of this procedure with a 0.070 inch thick foam results in a total thickness of about 75 mil plus or minus 10%.

When the sandwich variety of dampening material (mix extending as layers on both sides of the core) is desired one would proceed as above but allow the top layer to cure. After the top layer is cured the piece is flipped over and about 30 to 40 cc's of mix is applied to the reverse side of foam, allowed to level and squeegeed to provide a total thickness of, typically about 0.090 inch.

FIG. 8 illustrates a drum Dr having the drumhead Dh, the drum being typical of known percussion instruments. Applicants apply their adhesive material or patch (10) to an area of the drumhead, typically on the underside surface, for effectively dampening overtones.

FIG. 9 illustrates the stacking of two of applicants novel adhesive patches, one to the other, for variety in dampening characteristics.

FIG. 10 illustrates a variation of applicants novel dampening material that includes a woven core, which woven core may be either metallic or non metallic. For example, a metallic woven core may be a woven aluminum mesh, for example between 0.11 and 0.25 inch thick. The non metallic mesh may be woven fiberglass for example typically between 7 and 20 mil.

A typical size of applicants typical rectangular patch is between 1 inch wide and 3 inches long (60-70 mil thick±5 mil) and a typical area is between 1 sq. inch and 12 sq. inches. The dampening material typically has a resilient, elastomeric body and has a sticky or tacky surface typically in the range of 1 to 7 inch pounds. The tackiness may be selective as set forth above, with one side of the patch being tackier then the other. It has been found that applicants material, with a minimum of about 1 inch pound, preferably about 2 inch pounds and up to 7 inch pounds, can easily stick to the underside of a drumhead. Most prior art patches are not sticky enough to stay on the underside of the drumhead. Applicant has provided a novel patch that can stick to the underside of a drumhead.

In the manufacture of applicants novel dampening materials a large flat stock may be made (see FIG. 7H), which flat stock may be cut into strips and rolled up and may be die stamped into a variety of shapes (see FIGS. 6A-C). One such open cell foam substrate (12) is available from Reilly Foam Corporation, Conshohocken, Pa. as “100100 PPI Z”. The foams open cells allow the dampening material to at least partially absorb a poured polyurethane mix which will then cure at room temperature to be integral. The preferred mix contains little or no silicone or other oils. The preferred mix, after 24 hours attached to a drumhead leaves only a slight mark, compared to unsightly oil spots left by other oil bearing prior art patches.

An alternate preferred embodiment of applicants present invention comprises only a resilient pliable body of polyurethane mix, which is substantially oil free. This mix is available, as above, from KBS Chemical in Forth Worth. It makes an effective dampening material, with adhesive properties that allow it to stick to the surface of a vibrating drum, for a period of time without leaving an oil residue.

Applicant, in an alternate preferred embodiment, has found a thin patch, about 30 mil (+5 mil) has allowed a musician to “fine tune” a percussion instrument. Prior art patches do not illustrate such a thin dimension.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A device for dampening a vibratable surface comprising:
a patch comprising a resilient, pliable, adhesive body and an integral flexible base.

2. The device of claim 1 wherein the resilient pliable body is comprised of polyurethane.

3. The device of claim 1 wherein the body is substantially free of oil.

4. The device of claim 2 wherein the base is foam.

5. The device of claim 4 wherein the base is an open cell foam.

6. The device of claim 1 wherein the patch is rectangular.

7. The device of claim 1 wherein the patch is circular.

8. The device of claim 1 further including a second patch, the second patch for stacking on the first patch, the first patch for attaching to the vibratable surface.

9. The device of claim 4 wherein the polyurethane substantially saturates the foam.

10. The device of claim 4 wherein the patch includes a top and bottom surface and the foam is the same distance from the top surface as it is from the bottom surface.

11. The device of claim 4 wherein the patch includes a top and bottom surface and the foam is closer to one of the top surface or the bottom surface than the other.

12. The device of claim 1 wherein the patch is stickier on one side than the other.

13. A method of manufacturing a patch for application to a vibrating surface, the method comprising the steps of:
providing a flat surface;
applying the polyurethane mix to the flat surface;
laying a sheet of base material onto the polyurethane mix; and
allowing the polyurethane mix to cure.

14. The method of claim 13 wherein the providing step includes the step of providing a release sheet on the flat surface.

15. The method of claim 14 further including, after the laying step, a step of removing any trapped air from the mix prior to curing.

16. The method of claim 15 further including the step of cutting the cured/mixed sheet to a preselected shape.

17. The method of claim 16 wherein the preselected shape is a rectangle with an area between about 1 sq. inch and 12 sq. inches.

18. A device to dampen a vibratable surface device comprising:
a patch having an elastomeric body with a surface capable of adhering to the underside of a vibrating drumhead.

19. The device of claim 18 further including a substrate, the substrate integral with the body.

20. The device of claim 19 where the substrate is foam.

21. The device of claim 18 wherein the surface of the body requires at least one inch pound of force to remove it from the surface of the vibrating drumhead.

22. The device of claim 18 wherein the body is a non-colloidal body.

23. The device of claim 22 wherein the body is non-colloidal.

24. The device of claim 18 further including a skin attached to the protective body.

25. The device of claim 24 wherein the skin is a thin polyurethane sheet.

26. A method of dampening a vibrating drumhead, including the steps of providing a pliable, elastomeric patch having a body with an adhesive surface; and
applying the adhesive surface to the underside of a drumhead.
